(19) United States
(12) Patent Application Publication
(10) Pub. No.: US 2022/0335819 A1
(43) Pub. Date: Oct. 20, 2022

(54) Device, system and method for assisting mobile robots in autonomously crossing roads

(71) Applicant: STARSHIP TECHNOLOGIES OÜ, Tallinn (EE)

(72) Inventors: Ahti HEINLA, Tallinn (EE); Siim VIILUP, Tallinn (EE); Raivo RIIEL, Tallinn (EE)

(73) Assignee: STARSHIP TECHNOLOGIES OÜ, Tallinn (EE)

(21) Appl. No.: 17/765,416

(22) PCT Filed: Oct. 8, 2020
(86) PCT No.: PCT/EP2020/078249

§ 371 Date: Mar. 30, 2022

(30) Foreign Application Priority Data
Oct. 10, 2019 (EP) 19202513.8

(51) Int. Cl. G08G 1/01; G08G 1/09; G08G 1/052; G08G 1/056; G08G 1/16; B25J 9/16; H04W 4/44

(52) U.S. Cl. CPC G08G 1/0116; G08G 1/0141; G08G 1/0145; G08G 1/091; G08G 1/052; G08G 1/056; G08G 1/164; G08G 1/166; B25J 9/1666; H04W 4/44

(57) ABSTRACT

The current invention relates to a traffic detection device, including a sensor configured to detect an object of interest within its field of view, an energy supply unit, a communication unit, and a housing configured to encase all other components. Further, the present invention also relates to a system and method for assisting mobile robots. The system comprises at least one mobile robot configured to navigate in an unstructured outdoor environment as a traffic participant and at least one traffic detection system, wherein the traffic detection device is configured to assist the mobile robot by providing additional sensor data. The method includes a mobile robot approaching a road crossing, requesting assistance for the mobile robot, a traffic detection device providing at least one assistive function, and in response to the assistive function, the mobile robot crossing the road.

### FIELD

The invention relates to mobile robots. More specifically, the invention relates to radar and connectivity devices assisting mobile robots in their operations.

### INTRODUCTION

An increasing number of tasks in our daily life are carried out by robots and in particular mobile robots are becoming more and more common. Such robots are also travelling autonomously or semi-autonomously in public areas, for example to deliver items, function as mobile vending machines or provide security. Often these robots travel on pedestrian walkways with the aid of a plurality of inbuilt sensors to orientate themselves and travel safely and automatically through an unstructured surrounding. For the fulfilment of their tasks such robots may have to cross vehicle roads, such as public roads, driveways and other roads where cars and other vehicles may be encountered by the robot. Such crossings may present a challenge to the robot, in particular if the view of the robot is obstructed by obstacles. That is, if the sensors of the robot cannot fully assess the conditions on the road that needs crossing.

If the robot detects such a blind spot at a crossing, it may decide not to cross the road autonomously but rather call for help of a human operator, who may have access to the robot's sensors and remotely guide the robot across the road. However, in some situations also the human operator may not be able to guide the robot safely across the road based only on the data received from the robot's sensors. For example, if the view is blocked to an extend that also the operator cannot judge the situation at the crossing. Further, the aim of mobile robots is to ultimately navigate the streets fully autonomously, i.e. without the need of a human operator.

Obstacles and a crossing may for example be parked cars, signs, trees, pedestrians standing in front of the robot, walls, buildings, etc.

In many cases, the obstacles at road crossing points are permanent, e.g. road signs, trees, buildings, or at least stationary, e.g. parked cars. Typically, these obstacles block a particular field of view. In such instances it may be beneficial for the mobile robot to have access to external sensors that are permanently installed at critical road crossing points, e.g. a radar system monitoring the field of view that is blocked for the robot.

Such permanently installed sensors are already known for traffic control. For example, US 2011/0205086 A1 discloses a traffic control system including an arrangement of traffic lights at a traffic intersection, and a radar sensor installed at the intersection such that its field and range of detection covers at least one approach to the intersection. The radar sensor is adapted to sense the presence of vehicles within a predetermined field of view and range.

However, such systems are concerned with traffic control and, in some cases, detection of traffic violations and thus, do typically not share the sensor data with other traffic participants such as autonomous or semi-autonomous cars or robots. Therefore, it may be advantageous to install sensors at critical crossings that can be accessed by other traffic participants, such as mobile robots or cars.

### SUMMARY

It is the object of the present invention to provide external sensors that can communicate with traffic participants and provide data on objects, such as moving vehicles, in their field of view. It is further the object to optimize, streamline and facilitate mobile robot operations, particularly when crossing vehicle roads.

In a first embodiment, a traffic detection device is disclosed. The traffic detection device comprises a sensor configured to detect an object of interest within its field of view, an energy supply unit and a communication unit. Further, the traffic detection device comprises a housing configured to encase all other components.

The present traffic detection device may be particularly advantageous for assisting mobile robots navigating in an unstructured environment. For example, the mobile robot may be an item delivery robot, a vending robot or another type of service providing robot. For the successful execution of its task the robot may for example need to cross roads, such as vehicle roads. Typically, the mobile robot may rely on internal sensors to access the situation and identify a moment to cross the road without endangering other traffic participants and/or the mobile robot. However, there may be instances where the internal sensors may not be able to safely access the situation. For example, there may be obstacles blocking the field of view of the robot's sensors. In such cases a traffic detection device may advantageously provide an assistive function for the mobile robot, e.g., providing additional sensor data from a sensor with a different field of view. That is, the sensor of the traffic detection device may provide a different viewing angle and/or range compared to the sensors of the mobile robot. In other words, to assist or to provide an assistive function may for example comprise providing sensor data.

The term object of interest used herein may refer to any object in the field of view of the sensor, for example, obstacles, traffic lights, and particularly also moving objects such as other traffic participants.

The housing may be beneficial for protecting the other components of the traffic detection device from the ambient conditions. In particular from wind, rain, hail or snow, but also potentially from damage through individuals, such as vandalism.

In some embodiments, the sensor of the traffic detection device may be configured to detect the speed of any object of interest within its field of view. That is, the sensor may detect is an object is moving and what speed it is moving at.

In some embodiments, the sensor may be configured to detect the distance of any object of interest within its field of view. The distance of an object may be measured with respect to the sensor.

Additionally or alternatively, the sensor may be configured detect the direction of travel of any moving object of interest within its field of view. That is, the sensor may determine the direction in which an object is moving.

In general, sensor data on the speed, distance and/or direction of travel may be advantageous as it may enable estimating a trajectory of an object. That is, it may be possible to predict a position of an object at a given time in the future. This may for example enable the robot to determine a time at which it may cross a road without interfering with other moving objects.

In some embodiments, the object of interest detected by the sensor may be at least one of a traffic participant, a traffic light and an obstacle. This may be advantageous for assisting the mobile robot since a traffic participant may interfere with the path the mobile robot may travel and/or obstacles may block the way. Detecting a traffic light and particularly detecting the status of a traffic light may provide valuable information for crossing a road. For example, it may provide information on restrictions for crossing the road or times when other traffic participants may need to stop at said traffic light.

In some embodiments, the sensor may comprise a range R1. The range R1 may be up to 200 m, preferably up to 150 m, such as up to 75 m. Additionally or alternatively, the sensor may comprise an opening angle A1 of the field of view of the sensor. The opening angle A1 may be in the range of 5° to 180°, preferably 10° to 120°, more preferably 15° to 90°, such as 25°.

In some embodiments, the sensor of the traffic detection device may comprise at least one of a radar sensor, a visual mono or stereo camera, a time-of-flight camera and a Lidar sensor.

Generally, such sensors may be advantageous as they may provide sensor data that enable to detect objects of interest and potentially their distance, speed and/or direction. In particular a radar sensor, such as a Doppler radar sensor may be advantageous as it is well established for traffic control and relatively independent of the ambient conditions, e.g., rain or snow fall. Furthermore, the sensor data is typically smaller in size compared to sensor data of visual sensors, such as cameras, and they may also be advantageous in terms of privacy as no images are taken.

In some embodiments, the communication unit may comprise at least one slot for at least one Subscriber Identity Module (SIM card) and/or a modem and/or a network device.

The communication unit may be configured to exchange data with a server via cellular and/or wireless networks. That is, the communication unit may send and receive data to and from a remote server via wireless communication.

The communication unit may further be configured to share device status information with the server. The status of the device may for example comprise the current battery level, charging statistics, error messages and other important information relating to the operation of the traffic detection device.

Further, the communication unit may be configured to wirelessly communicate and/or exchange data with at least one mobile robot. That is, the traffic detection device may wirelessly exchange data with at least one mobile robot by means of the communication unit. For example, the traffic detection device may send sensor data to the mobile robot and/or it may receive a request for an assistive function from the mobile robot. The communication unit may wirelessly communicate with at least one mobile robot, via at least one of a wireless local area network (WLAN), a wireless personal area network (WPAN), such as Bluetooth®, a metropolitan area network (MAN), such as WiMAX, and other forms of wireless packet based private network connections.

In some embodiments the communication unit may be configured to amplify and/or extend a present wireless network. For example, the box may utilize a WLAN repeater to amplify a WLAN signal supplied to the traffic detection device by means of directional antennas for long distance transmission. This may be advantageous as it may enable a secure and stable connection, e.g. to the internet, in areas with otherwise low connectivity, e.g., without cellular network reception.

The wireless network provided by the communication unit may comprise a public identifier. Such a public identifier may for example be provided to mobile robots or other traffic participants to enable them to find and/or access the traffic detection device. This may be advantageous as a mobile robot may scan the area for known public identifiers and log into a known wireless network to request assistance in case of need. A public identifier may for example be a Service Set ID (SSID) in case the wireless network is a WLAN.

In some embodiments, the communication unit may be configured to broadcast sensor data such that mobile robots and other traffic participants may be able to access the sensor data without a request. That is, the sensor data may be continuously broadcasted to enable access to the sensor data without a request for assistance. In other cases outlined below, such a request may first be sent before the data is provided.

In some embodiments, the energy supply unit may be configured to be connected to mains. This may be advantageous in cases of high demand for electrical energy to ensure a constant supply of electrical energy. For example, if the device is configured to broadcast the sensor data it may require a constant flow of electrical energy to power the device and in particular the sensor and the communication unit.

In some embodiments, the energy supply unit may comprise a rechargeable battery. This may be advantageous as it may render the traffic detection device more flexible in terms of potential areas of use. That is, it may for example not always be possible or feasible to provide the traffic detection device with a connection to mains.

Further, the rechargeable battery may be configured to be removable and/or exchangeable. This may be advantageous for charging the battery. For example, an empty battery may be exchanged for a fully charged battery to ensure the functionality of the traffic detection device. After exchange the empty battery may be recharged for the next use.

The rechargeable battery may comprise a capacity in the range of 25 Wh to 500 Wh, preferably in the range of 50 Wh to 200 Wh, such as 100 Wh.

In some embodiments, the energy supply unit may further comprise a recharging mechanism for the rechargeable battery. That is, the rechargeable battery may generally be recharged within the traffic detection device or in other words, the battery may not require to be removed or exchanged for recharging. The recharging mechanism may be provided by a photovoltaic system configured to recharge the rechargeable battery. That is, the traffic detection device may comprise a photovoltaic system for recharging the battery. This may be advantageous as it may provide an autonomous way of recharging the battery. That is, the energy unit may be self-sufficient, or at least the frequency of external recharging may be reduced.

In some embodiments, the traffic detection device may further comprise a processing unit. The processing unit may be configured to control the traffic detection device, wherein controlling the traffic detection device may comprise at least one of acquiring and/or processing the data of the at least one sensor, sending or receiving and processing instructions, sensor data, operational data or the like via the communication unit, and managing the power consumption of the device.

Further, the processing unit may be configured to process sensor data to identify objects of interest and extract a corresponding speed and/or distance and/or direction.

The processing unit may comprise at least one microprocessor, such as central processing unit (CPU) and/or a at least one circuit, such as an application specific integrated circuit (ASIC), field-programmable gate arrays (FPGAs), etc.

Additionally or alternatively, the processing unit may comprise at least one memory such as at least one non-volatile storage device (e.g. a solid-state drive (SSD)) and/or at least one volatile storage device (e.g. random-access memory (RAM)). Further, machine-readable program code may be stored in the memory, configured to cause the processing unit to execute tasks and steps required to operate the traffic detection device when executed on the processor or circuit.

In some embodiments, the housing may be made from a polymer. For example, the housing may be made from a plastic, such as a thermoplastic.

The housing may comprise at least one transparent window, wherein the at least one transparent window may be made from glass or a transparent thermoplastic, such as acrylic glass. A transparent window may be advantageous for a visual sensor, which may require a line of sight to the detection area. Further, it may enable to provide a solar cell within the housing with sunlight.

In some embodiments, the housing may comprise a cutout configured to accommodate a solar cell. This may be advantageous as a transparent window may reduce the efficiency of a solar cell.

In some embodiments, the height L1 of the housing may lie in the range of 5 cm to 100 cm, preferably 20 cm to 50 cm, such as 25 cm. Additionally or alternatively, the width L2 of the housing may lie in the range of 5 cm to 50 cm, preferably 10 cm to 30 cm, such as 20 cm. Furthermore, the depth L3 of the housing may lie in the range of 2 cm to 30 cm, preferably 5 cm to 20 cm, such as 10 cm.

In some embodiments, the traffic detection system may comprise a mounting configured to securely fasten the housing to a support structure. This may be advantageous for the installation of the traffic detection device at a desired location. A support structure may for example be a wall or a post, such as a lamp post or a sign post.

The mounting may be made of a polymer, such as plastic, or a metal, or a combination thereof.

The mounting may comprise a housing attachment plate, configured to be attached to the housing by fastening means. Fastening means may for example be screws or rivets. Further the mounting may comprise at least one attachment plate, configured to be attached to a support structure, such as a wall or a post. Yet further, the at least one attachment plate may comprise openings, such as holes or groves to accommodate fastening means, such as screws or rivets.

Additionally, the at least one attachment plate may be attached to the housing attachment plate. In some embodiments, the at least one attachment plate may be attached to the housing attachment plate by means of a hinge. For example, by using a rivet.

In some embodiments, the mounting may comprise a hinge plate, wherein the housing attachment plate may be attached to one end of the hinge plate by means of a hinge and a first attachment plate may be attached to the opposite end of the hinge plate by means of a hinge. Further, the housing attachment plate may be attached to a second attachment plate by means of a hinge.

The mounting may be configured to enable an angle A2 between the housing and the support structure it is fastened to, that lies in the range of 0° to 90°, preferably 0° to 60°.

That is, the mounting may enable to mount the housing to a support structure such as a post or a wall. Additionally, it may allow for a tilted orientation of the housing with respect to the support structure. This may be advantageous as it may provide the means to adjust the field of view of the traffic detection sensor to cover at least a desired area.

In a second embodiment, a system for assisting mobile robots is disclosed. The system comprises at least one mobile robot configured to navigate in an unstructured outdoor environment as a traffic participant. The system further comprises at least one traffic detection device as described above, wherein the traffic detection device is configured to assist the mobile robot by providing additional sensor data.

In some embodiments of the system, the traffic detection device may be configured to assist the mobile robot upon request from the mobile robot. Additionally or alternatively, the traffic detection device may be configured to assist the mobile robot at a predetermined time. This may be advantageous as it may allow the traffic detection device to save power by entering a power save mode when no assistance is requested and/or required at a predetermined time.

In some embodiments of the system, the mobile robot may be an item delivery robot. That is, the mobile robot may be configured to deliver items, for example packages, food and/or beverages.

In some embodiments of the system, the traffic detection device may be configured to assist the mobile robot with road crossing. Additionally or alternatively, the traffic detection device may be configured to send sensor data to the mobile robot, said sensor data relating to conditions on the road. The sensor data may be reflective of a road region falling outside the mobile robot's field of view. This may be advantageous since the mobile robot may otherwise not be able to cross a road where at least a portion of the field of view of the sensors of the robot is blocked.

In some embodiments the system may further comprise a server configured to communicate and exchange data with the mobile robot and the traffic detection device. Preferably the server may be a remote server, i.e. a server that is at a location different to the location of the mobile robot and/or the traffic detection device.

The server may be configured to estimate a time at which the mobile robot will require an assistive function and provide the time estimate to the traffic detection device. That is, the server may estimate the time the mobile robot may need to navigate to the travel detection device, i.e. estimate navigational time of the mobile robot, and instruct the traffic control device of the time when a next assistive function may be needed. This time would then correspond or substantially correspond to the estimated time of arrival of the mobile robot to the location or operation area of the travel detection device (that may be in substantial vicinity of the placement of the travel detection device).

The traffic detection device may be configured to send sensor data to the server. Additionally, the server may be configured to send the sensor data to the mobile robot.

In some embodiments of the system the traffic detection device may be configured to provide a wireless internet connection for the mobile robot. This may be advantageous as there may be areas with bad connectivity for the mobile robot, e.g., areas with no or bad coverage of a cellular network.

Further, the system may in some embodiments comprise a plurality of mobile robots. That is, the traffic detection device may provide assistance to a plurality of mobile robots.

In a third embodiment, a method for assisting mobile robots is disclosed. The method comprises a traffic detection device providing at least one assistive function to a mobile robot. The assistive function may for example be providing sensor data of the traffic detection device sensor.

In some such embodiments, the method may comprise a mobile robot approaching a road crossing and requesting assistance for the mobile robot. The method may further comprise the traffic detection device providing at least one assistive function and in response to the assistive function, the mobile robot crossing the road. That is, in some embodiments the method for assisting a mobile robot may comprise assisting a mobile robot with crossing a road.

Further, the robot may be requesting assistance directly from the traffic detection device or via a remote sever.

In some embodiments of the method, the mobile robot may cross the road via a pedestrian road crossing.

In some embodiments, the method may comprise monitoring mobile robot operation in a predetermined region, estimating next time when assistance will be required by at least one mobile robot and instructing the traffic detection device of the estimated time. The method may further comprise the traffic detection device entering a power save mode until shortly before the estimated time and upon arrival of the mobile robot, the traffic detection system providing at least one assistive function. This may be advantageous as it may enable power efficient operation of the traffic detection device. That is, power may be saved in times where no assistance is required by a mobile robot

The method may comprise the traffic detection device entering a power save mode until 5 minutes before the estimated time, preferably 2 minutes, more preferably 1 minute before the estimated time.

In some embodiments, the method may comprise the traffic detection device being in a power save mode and the traffic detection device leaving the power save mode at fixed intervals to check whether assistive function is needed. The method may further comprise the traffic detection system providing at least one assistive function upon receiving a request of a mobile robot. In other words, the traffic detection device may periodically check if assistance is needed by a mobile robot and otherwise return in a power save mode. This may also be an advantageous method for reducing the power consumption of the traffic detection device during operation.

The assistive function may comprise at least one of providing sensor data and wireless internet connection. The sensor data may for example assist the robot by providing access to an area not covered by the sensors of the mobile robot, e.g. due to obstacles or range. Thus, they may enable the mobile robot to access the current situation and particularly identify moving objects such as other traffic participants. The wireless internet connection may be required for connecting to the server which may provide additional functionality, for example advanced algorithms. The wireless internet connection may for example also be required for requesting help from an external operator.

In some embodiments, the sensor data may be provided to the mobile robot directly from the traffic detection device or via the sever.

The traffic detection device may be as described above.

In some embodiments, the method may comprise the mobile robot scanning for public identifiers of wireless networks to identify known wireless networks. This may be advantageous as mobile robots or other traffic participants may for example have access to a database comprising public identifiers of traffic detection devices. Thus, by scanning for theses public identifiers they may identify devices nearby, log into the known wireless network and/or request assistance in case of need.

In some embodiments, the method may comprise a plurality of traffic detection devices providing sensor data to a mobile robot. Additionally, the method may further comprise providing the data via a wireless network and establishing a master-slave system between the plurality of traffic detection devices. In other words, if a plurality of traffic detection devices provides sensor data to a mobile robot this may for example be realized via a remote server. However, if the data is provided to the robot via a wireless network, the robot may only communicate with a single wireless network, i.e. the wireless network of one traffic device. Therefore, one traffic detection device—the master—may communicate with the mobile robot and provide the sensor data of the plurality of traffic detection devices, while the other traffic detection devices—the slaves—will provide their sensor data to the master. This may be advantageous as it may enable an efficient way of communication and in particular sharing sensor data between a mobile robot and a plurality of traffic detection devices.

In some embodiments, the sensor of the traffic detection device may only leave the power save mode if sensor data is required. This may be advantageous as the sensor may typically comprise a high power consumption compared to other components of the system. Thus, the sensor may only leave the power save mode if sensor data is needed. In other words, the sensor of the traffic detection device may only generate sensor data if the data is needed in line with an assistive function.

In some embodiments, the method may comprise utilizing the traffic detection device as described above and/or utilizing the system as described above.

In a fourth embodiment, a use of a device as described above or a system as described above for a method as described above is disclosed.

The use may be for autonomous or semi-autonomous robots, wherein the use may in some embodiments be for item delivery robots.

Alternatively, the use may be for autonomous or semi-autonomous vehicles, wherein the use may in some embodiments be for self-driving cars.

The mobile robot can be an autonomous or a semi-autonomous robot configured for ground-based travel. Note, that as used herein, the terms autonomous or semi-autonomous robot can be used to mean any level of automation depending on the task that the robot is performing. That is, the robot can be adapted to function autonomously or semi-autonomously for most of the tasks, but can also be remotely controlled for some other tasks. Then, the robot would be non-autonomous during the time it is controlled, and then autonomous and/or semi-autonomous again when it is no longer controlled. For example, the robot can assume any of the levels of automation as defined by the Society of Automotive Engineers (SAE), that is, the levels as given below.

### Level 0—No Automation

### Level 1—Driver Assistance

### Level 2—Partial Automation

### Level 3—Conditional Automation

### Level 4—High Automation

### Level 5—Full Automation

Though the levels usually refer to vehicles such as cars, they can also be used in the context of the mobile robot. That is, Level 0 can correspond to a remote terminal fully controlling the robot. Levels 1-4 can correspond to the remote terminal partially controlling the robot, that is, monitoring the robot, stopping the robot or otherwise assisting the robot with the motion. Level 5 can correspond to the robot driving autonomously without being controlled by a remote terminal such as a server or a remote operator (in this case, the robot can still be in communication with the remote terminal and receive instructions at regular intervals).

The present invention is also defined by the following numbered embodiments.

Below, reference will be made to device embodiments. These embodiments are abbreviated by the letter “D” followed by a number. Whenever reference is herein made to “device embodiments”, these embodiments are meant.

D1. A traffic detection device comprising
a sensor configured to detect an object of interest within its field of view;
an energy supply unit;
a communication unit; and
a housing configured to encase all other components.
   D2. The traffic detection device according to the preceding embodiment, wherein the sensor is configured to detect the speed of any object of interest within its field of view.
   D3. The traffic detection device according to any of the preceding embodiments, wherein the sensor is configured to detect the distance of any object of interest within its field of view.
   D4. The traffic detection device according to any of the preceding embodiments, wherein the sensor is configured detect the direction of travel of any moving object of interest within its field of view.
   D5. The traffic detection device according to any of the preceding embodiments, wherein the object of interest is at least one of
a traffic participant;
a traffic light; and
an obstacle.
   D6. The traffic detection device according to any of the preceding embodiments, wherein the sensor comprises a range R1 and wherein the range R1 is up to 200 m, preferably up to 150 m, such as up to 75 m.
   D7. The traffic detection device according to any of the preceding embodiments, wherein the sensor comprises an opening angle A1 of the field of view of the sensor and wherein the opening angle A1 is in the range of 5° to 180°, preferably 10° to 120°, more preferably 15° to 90°, such as 25°.
   D8. The traffic detection device according to any of the preceding embodiments, wherein the sensor comprises at least one of a radar sensor, a visual mono or stereo camera, a time-of-flight camera and a Lidar sensor.
   D9. The traffic detection device according to any of the preceding embodiments, wherein the communication unit comprises at least one slot for at least one Subscriber Identity Module (SIM card) and/or a modem and/or a network device.
   D10. The traffic detection device according to the preceding embodiment, wherein the communication unit is configured to exchange data with a server via cellular and/or wireless networks.
   D11. The traffic detection device according to the preceding embodiment, wherein the communication unit is further configured to share device status information with the server.
   D12. The traffic detection device according to any of the three preceding embodiments, wherein the communication unit is configured to wirelessly communicate and/or exchange data with at least one mobile robot.
   D13. The traffic detection device according to the preceding embodiment, wherein the communication unit wirelessly communicates with at least one mobile robot, via at least one of
a wireless local area network (WLAN);
a wireless personal area network (WPAN), such as Bluetooth®;
a metropolitan area network (MAN), such as WiMAX; and
other forms of wireless packet based private network connections.
   D14. The traffic detection device according to any of the preceding embodiments, wherein the communication unit is configured to amplify and/or extend a present wireless network.
   D15. The traffic detection device according any of the 2 preceding embodiments, wherein the wireless network provided by the communication unit comprises a public identifier.
   D16. The traffic detection device according to any of the preceding embodiments, wherein the communication unit is configured to broadcast sensor data such that mobile robots and other traffic participants may be able to access the sensor data without a request.
   D17. The traffic detection device according to any of the preceding embodiments, wherein the energy supply unit is configured to be connected to mains.
   D18. The traffic detection device according to any of the preceding embodiments, wherein the energy supply unit comprises a rechargeable battery.
   D19. The traffic detection device according to the preceding embodiment, wherein the rechargeable battery is configured to be removable and/or exchangeable.
   D20. The traffic detection device according to any of the 2 preceding embodiment, wherein the rechargeable battery comprises a capacity in the range of 25 Wh to 500 Wh, preferably in the range of 50 Wh to 200 Wh, such as 100 Wh.
   D21. The traffic detection device according to any of the 3 preceding embodiments, wherein the energy supply unit further comprises a recharging mechanism for the rechargeable battery.
   D22. The traffic detection device according to the preceding embodiment, wherein the recharging mechanism is provided by a photovoltaic system configured to recharge the rechargeable battery.
   D23. The traffic detection device according to any of the preceding embodiments, wherein the traffic detection device further comprises a processing unit.
   D24. The traffic detection device according to the preceding embodiment, wherein the processing unit is configured to control the traffic detection device.
   D25. The traffic detection device according to the preceding embodiment, wherein controlling the traffic detection device comprises at least one of
acquiring and/or processing the data of the at least one sensor;
sending or receiving and processing instructions, sensor data, operational data or the like via the communication unit; and
managing the power consumption of the device.
   D26. The traffic detection device according to any of the 3 preceding embodiments, wherein the processing unit is configured to process sensor data to identify objects of interest and extract a corresponding speed and/or distance and/or direction.
   D27. The traffic detection device according to any of the 4 preceding embodiments, wherein the processing unit comprises at least one microprocessor, such as central processing unit (CPU) and/or a at least one circuit, such as an application specific integrated circuit (ASIC), field-programmable gate arrays (FPGAs), etc.
   D28. The traffic detection device according to any of the 5 preceding embodiment, wherein the processing unit comprises at least one memory such as at least one non-volatile storage device (e.g. a solid-state drive (SSD)) and/or at least one volatile storage device (e.g. random-access memory (RAM)).
   D29. The traffic detection system according to the preceding embodiment, wherein machine-readable program code is stored in the memory, configured to cause the processing unit to execute tasks and steps required to operate the traffic detection device when executed on the processor or circuit.
   D30. The traffic detection device according to any of the preceding embodiments, wherein the housing is made from a polymer.
   D31. The traffic detection device according to any of the preceding embodiments, wherein the housing comprises at least one transparent window.
   D32. The traffic detection device according to the preceding embodiment, wherein the at least one transparent window is made from glass or a transparent thermoplastic.
   D33. The traffic detection device according to any of the preceding embodiments, wherein the housing comprises a cutout configured to accommodate a solar cell.
   D34. the traffic detection device according to any of the preceding embodiments, wherein the height L1 of the housing lies in the range of 5 cm to 100 cm, preferably 20 cm to 50 cm, such as 25 cm.
   D35. the traffic detection device according to any of the preceding embodiments, wherein the width L2 of the housing lies in the range of 5 cm to 50 cm, preferably 10 cm to 30 cm, such as 20 cm.
   D36. the traffic detection device according to any of the preceding embodiments, wherein the depth L3 of the housing lies in the range of 2 cm to 30 cm, preferably 5 cm to 20 cm, such as 10 cm.
   D37. The traffic detection device according to any of the preceding embodiments, wherein the traffic detection system comprises a mounting configured to securely fasten the housing to a support structure.
   D38. The traffic detection device according to the preceding embodiment, wherein the mounting is made of a polymer, or a metal, or a combination thereof.
   D39. The traffic detection device according to any of the two preceding embodiments, wherein the mounting comprises a housing attachment plate, configured to be attached to the housing by fastening means.
   D40. The traffic detection device according to the preceding embodiment, wherein the mounting comprises at least one attachment plate, configured to be attached to a support structure.
   D41. The traffic detection device according to the preceding embodiment, wherein the at least one attachment plate comprises openings, such as holes or groves to accommodate fastening means.
   D42. The traffic detection device according to the preceding embodiment, wherein the at least one attachment plate is attached to the housing attachment plate.
   D43. The traffic detection device according to the preceding embodiment, wherein the at least one attachment plate is attached to the housing attachment plate by means of a hinge.
   D44. The traffic detection device according to any of the preceding embodiments, including the features of D41, wherein the mounting comprises a hinge plate.
   D45. The traffic detection device according to the preceding embodiment, wherein the housing attachment plate is attached to one end of the hinge plate by means of a hinge;
a first attachment plate is attached to the opposite end of the hinge plate by means of a hinge; and
the housing attachment plate is attached to a second attachment plate by means of a hinge.
   D46. The traffic detection device according to the preceding embodiment, wherein the mounting is configured to enable an angle A2 between the housing and the support structure it is fastened to, that lies in the range of 0° to 90°, preferably 0° to 60°.

Below, reference will be made to system embodiments. These embodiments are abbreviated by the letter “S” followed by a number. Whenever reference is herein made to “system embodiments”, these embodiments are meant.

S1. A system for assisting mobile robots, the system comprising
at least one mobile robot configured to navigate in an unstructured outdoor environment as a traffic participant;
at least one traffic detection device according to any of the preceding device embodiments;
wherein the traffic detection device is configured to assist the mobile robot by providing additional sensor data.
   S2. The system according to the preceding embodiment wherein the traffic detection device is configured to assist the mobile robot upon request from the mobile robot.
   S3. The system according to any of the preceding system embodiments wherein the traffic detection device is configured to assist the mobile robot at a predetermined time.
   S4. The system according to any of the preceding system embodiments wherein the mobile robot is an item delivery robot.
   S5. The system according to any of the preceding system embodiments wherein the traffic detection device is configured to assist the mobile robot with road crossing.
   S6. The system according to any of the preceding system embodiments wherein the traffic detection device is configured to send sensor data to the mobile robot, said sensor data relating to conditions on the road.
   S7. The system according to the preceding embodiment wherein the sensor data is reflective of a road region falling outside the mobile robot's field of view.
   S8. The system according to any of the preceding system embodiments wherein the system further comprises a server configured to communicate and exchange data with the mobile robot and the traffic detection device.
   S9. The system according to the preceding embodiment, wherein the sever is configured to estimate a time at which the mobile robot will require an assistive function and provide the time estimate to the traffic detection device.
   S10. The system according to the penultimate embodiment, wherein the traffic detection device is configured to send sensor data to the server.
   S11. The system according to the preceding embodiment, wherein the server is configured to send the sensor data to the mobile robot.
   S12. The system according to any of the preceding system embodiments, wherein the traffic detection device is configured to provide a wireless internet connection for the mobile robot.
   S13. The system according to any of the preceding system embodiments, wherein the system comprises a plurality of mobile robots.

Below, reference will be made to method embodiments. These embodiments are abbreviated by the letter “M” followed by a number. Whenever reference is herein made to “method embodiments”, these embodiments are meant.

M1. A method for assisting mobile robots, the method comprising a traffic detection device providing at least one assistive function to a mobile robot.
M2. The method according to the preceding method embodiment, wherein the method comprises
the mobile robot approaching a road crossing;
requesting assistance for the mobile robot;
the traffic detection device providing at least one assistive function; and
in response to the assistive function, the mobile robot crossing the road.
   M3. The method according to the preceding method embodiment, wherein the robot is requesting assistance directly from the traffic detection device or via a remote sever.
   M4. The method according to any of the preceding method embodiments, wherein the mobile robot crosses the road via a pedestrian road crossing.
   M5. The method according to any of the preceding method embodiments, with the features of M1, wherein the method comprises
monitoring mobile robot operation in a predetermined region;
estimating next time when assistance will be required by at least one mobile robot;
instructing the traffic detection device of the estimated time;
the traffic detection device entering a power save mode until shortly before the estimated time; and
upon arrival of the mobile robot, the traffic detection system providing at least one assistive function.
   M6. The method according to the preceding method embodiment, wherein the method comprises the traffic detection device entering a power save mode until 5 minutes before the estimated time, preferably 2 minutes, more preferably 1 minute before the estimated time.
   M7. The method according to any of the preceding method embodiments, with the features of M1, wherein the method comprises
the traffic detection device being in a power save mode;
the traffic detection device leaving the power save mode at fixed intervals to check whether assistive function is needed;
upon receiving a request of a mobile robot, the traffic detection system providing at least one assistive function.
   M8. The method according to any of the preceding method embodiments wherein the assistive function comprises at least one of providing sensor data and wireless internet connection.
   M9. The method according to the preceding embodiment, wherein the sensor data is provided to the mobile robot directly from the traffic detection device or via the sever.
   M10. The method according to any of the preceding method embodiments wherein the traffic detection device is as described in any of the device embodiments.
   M11. The method according to any of the preceding method embodiments, wherein the method comprises the mobile robot scanning for public identifiers of wireless networks to identify known wireless networks.
   M12. The method according to any of the preceding method embodiments, wherein the method comprises a plurality of traffic detection devices providing sensor data to a mobile robot.
   M13. The method according to the preceding method embodiment, wherein the data is provided via a wireless network and wherein the method comprises establishing a master-slave system between the plurality of traffic detection devices.
   M14. The method according to any of the preceding method embodiments, wherein the sensor of the traffic detection device may only leave the power save mode if sensor data is required.
   M15. The method according to any of the preceding method embodiments, wherein the method comprises utilizing the traffic detection device according to any of the preceding device embodiments and/or utilizing the system according to any of the preceding system embodiments.

Below, reference will be made to use embodiments. These embodiments are abbreviated by the letter “U” followed by a number. Whenever reference is herein made to “use embodiments”, these embodiments are meant.

U1. Use of a device according to any of the preceding device embodiments or a system according to any of the system embodiments for a method according to any of the preceding method embodiments.
U2. Use according to the preceding embodiment for autonomous or semi-autonomous robots.
U3. Use according to the preceding embodiment for item delivery robots.
U4. Use according to use embodiment U1 for autonomous or semi-autonomous vehicles.
U5. Use according to the preceding embodiment for self-driving cars.

Embodiments of the present invention will now be described with reference to the accompanying drawings. These embodiments should only exemplify, but not limit, the present invention.

### BRIEF DESCRIPTION OF THE DRAWINGS

FIG. 1 schematically depicts an embodiment of a traffic detection device;

FIG. 2 schematically depicts a mobile robot being assisted as per an embodiment of the invention;

FIG. 3 illustrates the field of view of a sensor of the present invention;

FIGS. 4A and 4B schematically depict communication between a traffic detection device and a plurality of mobile robots according to embodiments of the present invention;

FIG. 5 illustrates a mobile robot being assisted as per another embodiment of the invention;

FIG. 6 schematically depicts an embodiment of an energy supply unit;

FIG. 7 shows a flow diagram of a method according to an embodiment of the invention;

FIG. 8 depicts a housing according to an embodiment of the invention;

FIGS. 9A and 9B show a mounting according to an embodiment of the invention; and

FIG. 10 shows an embodiment of a mobile robot as per an embodiment of the present invention.

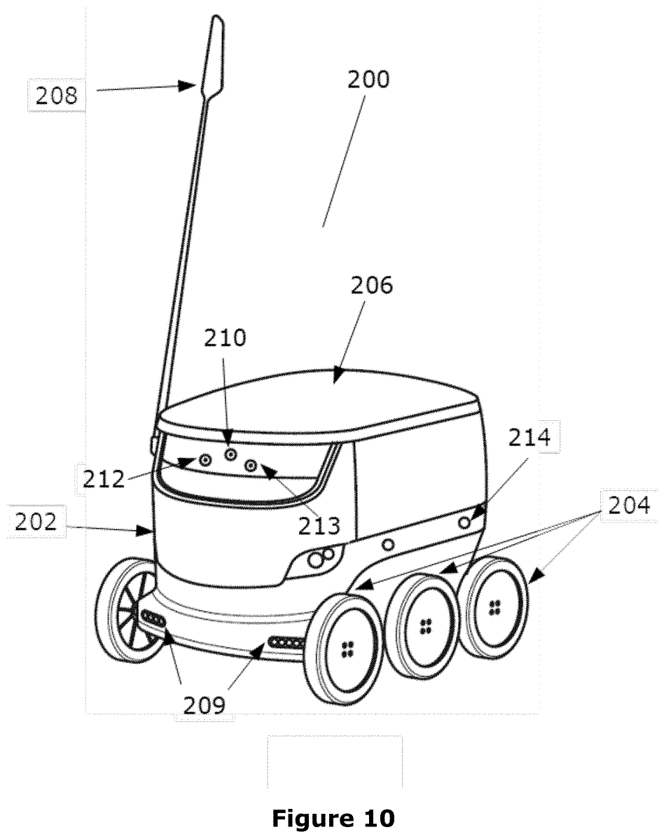

### DESCRIPTION OF EMBODIMENTS

It is noted that not all the drawings carry all the reference sings. Instead, in some of the drawings, some of the reference sings have been omitted for the sake of brevity and simplicity of the illustration. Embodiments of the present invention will now be described with reference to the accompanying drawings.

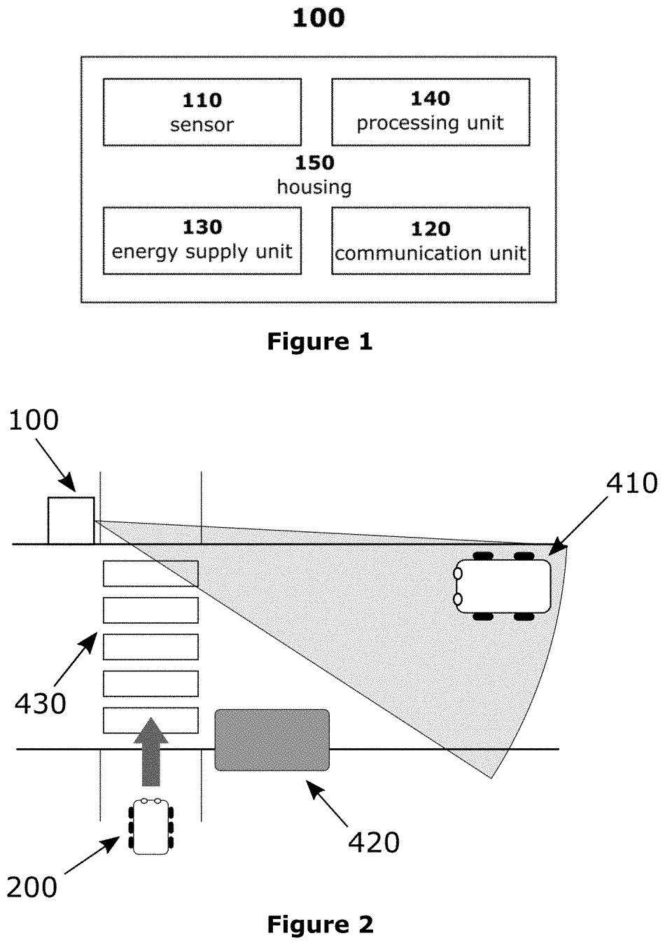

FIG. 1 schematically shows an embodiment of a traffic detection device 100, according an aspect of the present invention. The traffic detection device 100 comprises at least one sensor 110, a communication unit 120, an energy supply unit 130 and a processing unit 140, which are all surrounded by a housing 150.

The at least one sensor 110 of the traffic detection device 100 may be configured to detect objects in its field of view. That way the sensor data may contribute to the situational awareness and navigation capabilities of a mobile robot 200. Particularly, the sensor 110 may be configured to detect moving objects that may move in a plurality of directions within the sensor's field of view, such as other traffic participants.

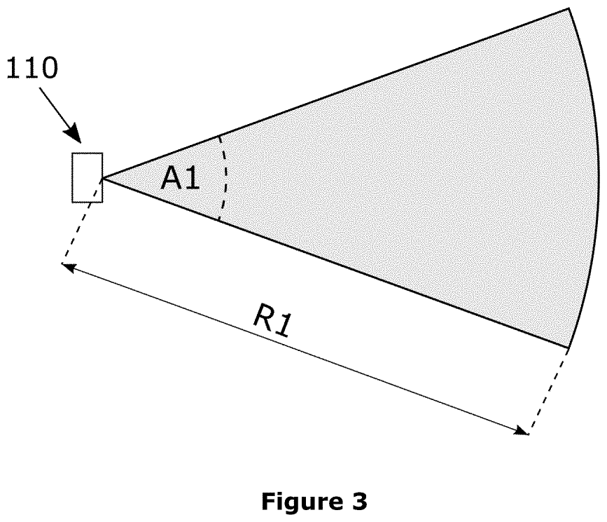

An exemplary setting for the use of a traffic detection device 100 is given in FIG. 2. Here, a mobile robot 200 is approaching a vehicle road with a crossing 430 which it needs to cross in order to fulfill the current delivery task. When approaching the crossing 430, the mobile robot 200 uses its internal sensors to assess the surrounding and in particular the vehicle road in order to identify the right moment for crossing the road without endangering other traffic participants and/or itself. However, at this crossing 430 there is an obstacle 420 obscuring the robot's line of sight in a particular direction. That is, in the situation depicted in FIG. 2 the mobile robot 200 cannot assess the conditions on the vehicle road to its right since the obstacle 420 is blocking its view.

The obstacle 420 could be permanent, e.g. a big tree, a road sign, a wall or a building, or it could be semi-permanent, e.g. a parked car or truck. In particular if the obstruction is permanent, or if statistics show that for example a car is parking in this spot for most of the times when a robot wants to cross, a traffic detection device 100 may be permanently installed at the crossing 430, covering at least the part of the vehicle road for which the view of the mobile robot 200 is obstructed. The field of view of the traffic detection device 100 in FIG. 2 is indicated by the grey circular sector.

In the depicted situation the at least one sensor 110 of the traffic detection device 100 will detect the object 410, more specifically in this situation the car 410. Further, the sensor 110 may be configured to provide data on the speed and distance of any object 410 in its field of view. That is, the sensor 110 may provide data from which the distance and speed of said object 410 can be extracted with a known uncertainty.

In some embodiments of the present invention the sensor 110 may further provide data on the direction of travel of any moving object in the sensor's field of view, such as other traffic participants.

The traffic detection device 100 may send the sensor data to the mobile robot 200 using the communication unit 120, either directly or via a remote server 300. In this way the mobile robot 200 can assess the situation and safely cross the vehicle road.

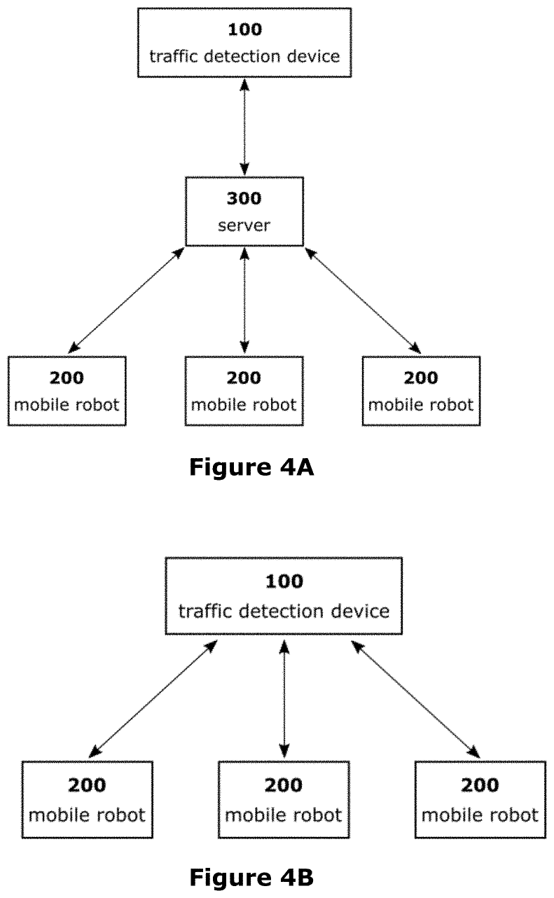

With regard to FIG. 3, the field of view of the sensor may be characterized by a detection range R1 and an opening angle A1. That is, the area in which the sensor may reliably detect objects and gather data for determining their corresponding speed and distance, i.e. the sensor's field of view, may be described by R1 and A1. The detection range R1 may be up to 200 m, preferably up to 150 m such as up to 75 m and the opening angle A1 may be in the range of 5° to 180°, preferably 10° to 120°, more preferably 15° to 90°, such as 25°.

Therefore, the at least one sensor 110 may provide data on objects in a predetermined field of view to the mobile robot 200. That is, the field of view may be determined by the position and orientation the traffic detection device 100, that comprises the sensor 110, is mounted in. In particular, the traffic detection device 100 may be mounted such that the sensor 110 may provide data on areas that lie outside of the mobile robot's field of view, e.g. due to known, permanent obstruction on particular road crossings. Therefore, the sensor data may for example enable the mobile robot 200 to assess the traffic situation at a road crossing 430 and help identifying potentially hazardous moving objects to enable safe crossing of a road.

The at least sensor 110 may comprise at least one of a visual mono or stereo camera, a lidar sensor, a radar sensor, a time of flight sensor and/or other sensors. Preferably, the sensor 110 may comprise a radar sensor, such as a Doppler radar. This may be advantageous for the following reasons: A radar sensor is relatively independent of the ambient conditions. That is, a radar sensor is not very sensitive to weather conditions, such as rain or snowfall, and changing light conditions due to operation during day and night. Furthermore, the data that needs to be transmitted wirelessly to the mobile robot 200 is typically less than for example for a visual camera. In addition, radar sensors are well established for monitoring of traffic on roads and especially for traffic control. They are also interesting with regards to privacy concerns as they do not take images as for example visual camera sensors do.

The communication unit 120 may comprise at least one slot for at least one Subscriber Identity Module (SIM card) and/or a modem and/or a network device, which may comprise an eSIM and/or a similar chip/system. In some cases, the use of two SIM cards and/or modems may be an advantage, since it increases reliability and allows for simultaneous communication via both SIM cards and/or modems for larger and/or faster transmission. In particular, two different mobile operators may be used for using the two SIM cards and/or modems in order to increase reliability of the connection.

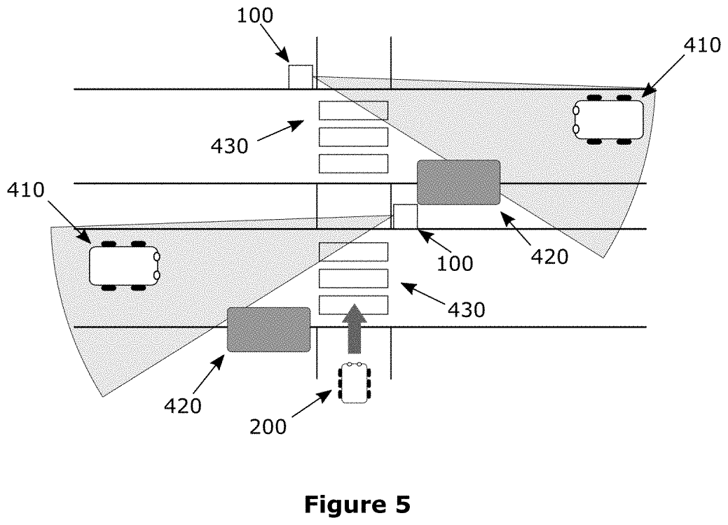

Referring to FIG. 4A, in some embodiments the communication unit 120 may be configured to exchange data with a remote server 300 via cellular networks. In particular, the traffic detection device 100 may transfer the sensor data to the remote server 300. Subsequently the remote server 300 may for example further analyze the data and/or send the data to at least one mobile robot 200. That is, the traffic detection device 100 may communicate with one or more mobile robots 200 through the remote server 300 and for example provide the sensor data.

In addition, the traffic detection device 100 may share data on the status of the device, such as charging statistics and current battery level, error messages and other important information with the remote server 300. Thus, servicing of the device 100 may be optimized with regards to the current device status.

Further, the server 300 may provide the traffic detection device 100 with information about the time when a next mobile robot 200 may require assistance within the area of the device. This may be beneficial as the traffic detection device 100 may go into a power saving mode and only wake up shortly before the expected arrival of a mobile robot 200 in need of assistance, therefore reducing the overall energy consumption of the traffic detection device 100.

Further, the communication unit 120 may be configured to wirelessly communicate directly with at least one mobile robot 200 as depicted in FIG. 4B or, in some embodiments, also other traffic participants such as self-driving cars. The wireless communication may be established using for example at least one of a wireless local are network (WLAN), a wireless personal network (WPAN), such as Bluetooth®, a metropolitan area network (MAN), such as WiMAX or other forms of wireless packet-based private network connections.

Not depicted in FIG. 4B is the sever 300 which may still be present and which may still share other kinds of data with both the traffic detection device 100 and/or the mobile robot 200. For example, the server 300 may provide the traffic detection device 100 with information about the time when a next mobile robot 200 may require assistance.

In addition, the traffic detection device 100 may share data on its location and orientation relative to the crossing and/or the detection range R1 of the sensor 110 and the opening angle A1 of the sensor's field of view. The mobile robot 100 may require this contextualizing data in order to make use of the sensor data.

The networks provided by traffic detection devices 100 may be known to mobile robots 200 and potentially other traffic participants that may be enabled to access the sensor data, e.g. by means of a public identifier. That is, for example in the case of a WLAN the mobile robot 200 may know the Service Set IDs (SSIDs) associated with traffic detection devices 100. Thus, the robot 200 can scan for said identifiers and log into the wireless network to request assistance of the traffic detection device 100 in case of need. If the traffic detection device 100 does not provide a wireless network the mobile robot 200 may send a request via the server 300.

With regards to some embodiments, the communication unit 120 may be configured to amplify and/or extend a present wireless network, e.g. using a WLAN repeater. Depending on the area the traffic detection box is mounted in, the box may for example be supplied with a WLAN signal by using directional antennas for long distance transmission.

In some embodiments, the communication unit 120 may be configured to broadcast the sensor data. Therefore, mobile robots 200 and, in some cases, other traffic participants may be able to access the sensor data without first sending a request to the traffic detection device 100. In other embodiments, such a request may be first sent by mobile robots 200 as outlined above and below.

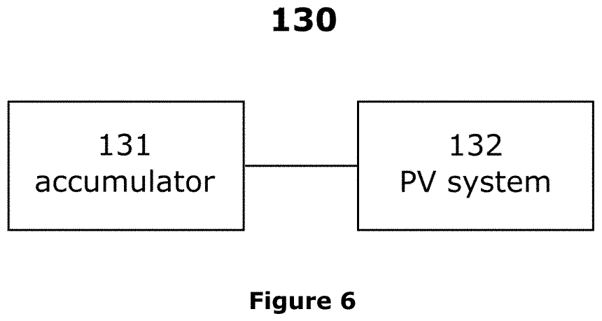

In some cases, a crossing 430 might require more than one traffic detection device 100. For example, if there are a plurality of obstacles obstructing the robot's view in multiple directions. An exemplary situation is depicted in FIG. 5, where the mobile robot 200 has to cross a two-lane road with a safety island between the two lanes. Here, two obstacles are obscuring the robot's view in two different places and directions. Therefore, the mobile robot 100 may require the assistance of two (or more) traffic detection devices 100.

In embodiments where the data between the mobile robot 200 and the traffic detection device 100 is shared directly via a wireless connection, a master-slave system may be established since the mobile robot 200 can only connect to a single wireless network. That is, the plurality of traffic detection devices 100 may determine a master traffic detection device which communicates with the mobile robot 200. The other traffic detection devices will function as slaves that only provide data to the master traffic detection device, which may then send the data of the plurality of traffic detection device 100 to the mobile robot 200 via a single wireless connection.

Further to sharing data, the communication unit 120 of the traffic detection device 100 may also be used to provide connectivity to mobile robots 200. For save operation and navigation the mobile robot 200 may require a connection to the server 300 via a wireless or cellular network. In some cases, the connection provided by the robot's communication unit may be insufficient, e.g. due to bad cellular network coverage close to the ground. In those cases, the traffic detection device 100 may also provide an internet connection for the mobile robot 100. This may be beneficial, as the traffic detection device 100 is typically mounted in an elevated position and thus, generally achieves a better connection for example to the cellular network.

In some embodiments, the energy unit 130 may be configured to be connected to mains comprising a wired connection.

In other embodiments, the energy supply unit 130 comprises a rechargeable battery 131, which may also interchangeably be referred to as accumulator 131. The energy supply unit 130 may be configured such that the rechargeable battery 131 is removable. That is, the rechargeable battery 131 may easily be removed and exchanged, e.g. for charging of the accumulator 131 outside of the traffic detection device 100. Such a rechargeable battery 131 may be advantageous since a wired connection may not be readily available at an installation site of the traffic detection device 100.

The rechargeable battery 131 may comprise a capacity configured to maintain the operation of the device for minimum time of 12 hours, preferably 24 hours, more preferably multiple days, such as weeks. The capacity is a tradeoff between the operation time and the size and cost of the rechargeable battery 131. Preferably the capacity is in the range of 25 Wh to 1000 Wh, more preferably in the range of 50 Wh to 500 Wh, such as 100 Wh.

Further, the energy supply unit 130 may comprise a recharging mechanism for the accumulator 131. This may enable autonomous operation of the traffic detection device 100 and reduce the required service time as the rechargeable battery 131 may not require exchanging for recharging.

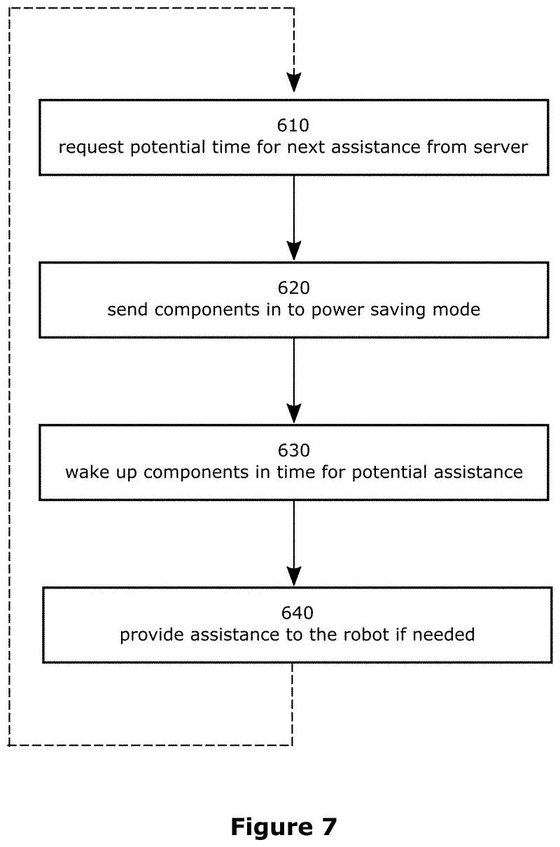

In a preferred embodiment as depicted in FIG. 6, the recharging mechanism is provided by a photovoltaic (PV) system 132. The photovoltaic system 132 may comprise at least one solar panel configured to generate electrical power to recharge the accumulator 131. Since the traffic detection device 100 is typically placed in an outdoor environment the photovoltaic system 132 may provide an efficient and compact way of generating electrical power for the traffic detection device 100. Furthermore, photovoltaic systems are typically nearly maintenance free, which may be advantageous with regards to service time for the device.

In order to maximize the operation time of the traffic detection device 100, the power consumption may be optimized in different ways during operation.

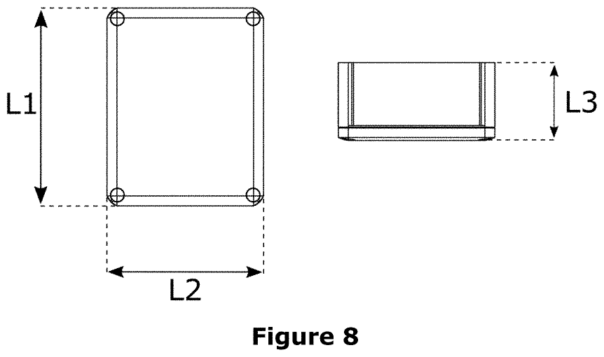

As mentioned before, one method for power saving may be to send at least some of the components to a power saving mode. A possible embodiment of such a procedure is depicted in the flow chart in FIG. 7. In a first step 610, the traffic detection device 100 requests an estimate for the next time the assistance of the device may be required by a mobile robot 200 from the server 300. The server 300 may be connected to a plurality of mobile robots 200 and may estimate the navigational time of the mobile robots to the installation point of the traffic detection device 100 in case it is on the desired route of the robot.

Based on the estimated time for the next required assistive function, the traffic detection device 100 may send at least one component in to power saving mode (step 620). That is one or more components might shut down or enter a mode with less power consumption. In some embodiments, all components might enter a power saving mode and/or shut down for some time.

After a set time, the components will wake up again and enter normal operation (step 630). The time is chosen such that the device is up and running before the mobile robot 200 is expected to arrive. For example, the traffic detection device 100 or its components may wake up 5 minutes before the estimated arrival time, preferably 2 minutes, more preferably 1 minute.

Once the mobile robot 200 arrives at the site of the traffic detection device 100 it may provide assistance if needed (step 640) and, after successful crossing of the robot, go back to step 610 and request the next potential time for an assistive function.

In another embodiment, the traffic detection device 100 may check for the presence of a mobile robot 200 in predefined intervals and go into a power saving mode in between those regular checks if no mobile robot 200 is present.

Preferably, the at least one sensor 110 may only be activated if assistance is requested. That is, the sensor 110 may still be in a power saving mode even if the other components are not in power saving mode. In other words, the sensor 110 may only start to generate data once the traffic detection device 100 has received a request for assistance from a mobile robot 200.

The processing unit 140 of the traffic detection device 100 may be configured to control the traffic detection device 100. Such control may comprise controlling the sensor 110, e.g. acquire and/or process the data of the at least one sensor 110, controlling the communications unit 120, e.g. sending or receiving and processing instructions, sensor data, operational data or the like, and managing the power consumption of the device. The processing unit 140 may generally serve to operate the traffic detection device 100.

The processing unit 140 may comprise at least one microprocessor, such as central processing unit (CPU) and/or a at least one circuit, such as an application specific integrated circuit (ASIC), field-programmable gate arrays (FPGAs), etc. Further, it may comprise at least one memory such as at least one non-volatile storage device (e.g. a solid-state drive (SSD)) and/or at least one volatile storage device (e.g. random-access memory (RAM)). Machine-readable program code may be stored in the memory. When executed on the processor or circuit, the machine-readable code may be configured to cause the processing unit 140 to execute the tasks and steps required to operate the traffic detection device 100.

In other embodiments of the present invention, the traffic detection device 100 may not comprise a processing unit 140. In such embodiments the communication unit 120 may for example directly send sensor data to a mobile robot or a remote server.

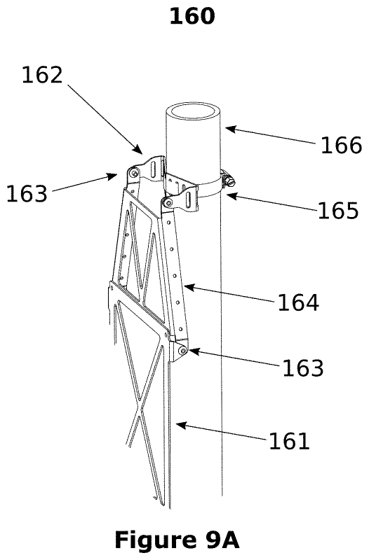

With reference to FIG. 8, the housing 150 of the traffic detection device 100 may surround all other components and may be configured to protect the components from environmental influences. The housing 150 may be made from a polymer, such as a plastic. This might be advantageous, as plastic housings are readily available and cheap while providing a good level of protection to the components within the housing. Furthermore, some sensors may be able to operate from within the housing without the use if a transparent window, e.g. a radar sensor may operate from within a plastic housing.

In some embodiments, the housing 150 may comprise at least one transparent window (not shown) to enable operation of visual sensors such as cameras or operation of a solar cell of the PV system 132 within the housing. The transparent window may be made from glass or preferably a transparent thermoplastic, such as acrylic glass.

In other embodiments, there may be a cutout in the housing 150 (not shown) to accommodate a solar cell of the PV system 131. The cutout may be configured to exactly accommodate the solar cell such that it may be hermetically sealed using sealants, such as silicone. This configuration may be advantageous, since the efficiency of the solar cell may be reduced if placed behind a transparent window.

Further, the housing 150 may also comprise internal mountings to securely fasten all other components of the traffic detection device 100.

The housing 150 may generally be box-shaped, that is the housing may be a rectangular box. However, it will be appreciated by the person skilled in the art, that the housing 150 may also take different forms, such as for example a cylindrical housing, without altering its function.

The dimensions of the housing may be characterized by height L1, width L2 and depth L3. The height L1 may typically lie in the range of 5 cm to 100 cm, preferably 20 cm to 50 cm, such as 25 cm and the width L2 may generally lie in the range of 5 cm to 50 cm, preferably 10 cm to 30 cm, such as 20 cm. The depth L3 may lie in the range of 2 cm to 30 cm, preferably 5 cm to 20 cm, such as 10 cm.

In some embodiments the traffic detection device 100 may further comprise a mounting 160, which may be configured to securely fasten the housing to a support structure, such as a wall or a post. Individual parts of the mounting may be made from different materials, for example polymers, such as plastic, or metal, such as aluminum or steel.

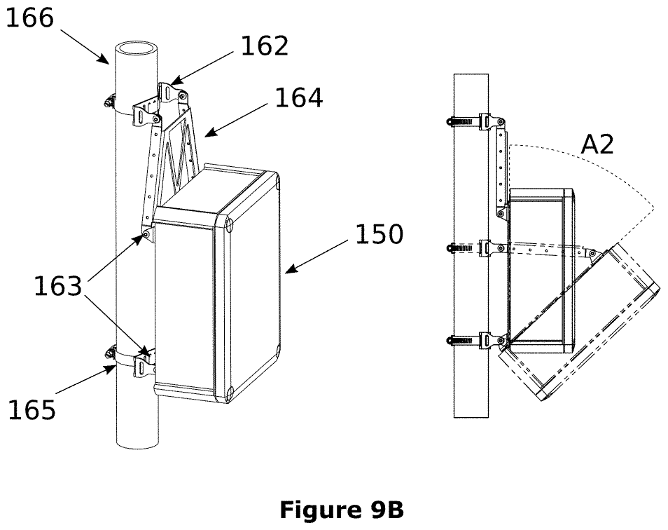

An embodiment of such a mounting 160 is depicted in FIGS. 9A and 9B for the case of mounting the traffic detection device on a post 166, e.g. a lamp post or traffic sign post.

Generally, the mounting 160 may comprise a housing attachment plate 161 (not fully shown), which may be attached to the back of the housing 150 by fastening means, such as screws or rivets. Further, the mounting 160 may comprise at least one attachment plate 162, designed to be attached to for example a wall or preferably a post 166, such as a sign or lamp post. Said attachment plate 162 may comprise openings to accommodate fastening means, such as screws, rivets, or in some embodiments a pipe clamp 165. That is, the attachment plate 162 may for example comprise holes and/or grooves configured to receive screws, rivets or a pipe clamp 165 as depicted in FIG. 9A.

Further the at least one attachment plate 162 be configured to at least partially follow the shape of the surface it is mounted to. That is, in the case of mounting the attachment plate to a wall it may be flat, whereas in the case of mounting it to a post it may me bend to approximate the circular shape thereof.

The at least one attachment plate 162 may be attached to the housing attachment plate 161. In some embodiments the attachment may comprise a hinge 163, e.g. a simple hinge by using a rivet.

In some embodiments the mounting may further comprise a hinge plate 164. The hinge plate 164 may be attached to the housing attachment plate 161 at one side and to the attachment plate 162 at the opposite side, wherein both attachments may comprise a hinge 163, e.g. by using a rivet. Further, the housing attachment plate 161 may be attached to a second attachment plate 162, also by means of a hinge 163. This arrangement is depicted in FIG. 9B and may have the advantage, that the angle A2 between the housing 150 and the surface it is mounted to may be altered by changing the position of the attachment plates 162, as illustrated in FIG. 9B. Therefore, the mounting may enable optimization of the orientation of the traffic detection device 100 and thus the sensor 110.

The angle A2 may preferably be adjustable in the range from 0° to 90° and more preferably 0° to 60°, to ensure enough flexibility to enable mounting of the traffic detection device 100 in a preferred position.

FIG. 8 demonstrates an exemplary embodiment of the mobile robot 200. The mobile robot 200 may be a delivery or a vending robot, that is, it may be configured to autonomously or semi-autonomously transport and deliver packages, consumable items, groceries or other items to customers. Preferably, the mobile robot 200 comprises a beverage module (not shown in the figure).

The mobile robot 200 comprises a robot body 202. The body 202 comprises an item compartment in which items can be placed and transported by the robot (not shown in the present figure).

The mobile robot 200 further comprises a robot motion component 204. In the present embodiment, the robot motion component 204 comprises six wheels 204. This can be particularly advantageous for the mobile robot 200 when traversing curbstones or similar obstacles on the way to (or return from) the delivery recipients.

Additionally, the mobile robot 200 comprises a lid 206. The lid 206 may be placed over the item compartment and locked to prevent unauthorized access to the beverage module.

The mobile robot 200 further comprises a robot signaling device 208, depicted here as a flagpole or stick 208, used to increase the visibility of the robot 200. Particularly, the visibility of the mobile robot 200 during road crossings may be increased. In some embodiments, the signaling device 208 may comprise an antenna.

The mobile robot 200 also comprises robot headlights 209 configured to facilitate the robot's navigation in reduced natural light scenarios and/or further increase the robot's visibility. The headlights are schematically depicted as two symmetric lights 109, but can comprise one light, a plurality of lights arranged differently and other similar arrangements.

Further, the mobile robot 200 comprises robot sensors 210, 212, 213, 214. The sensors are depicted as visual cameras (210, 212, 213) and ultrasonic sensors (214) in the figure, but can also comprise radar sensors, lidar sensors, time of flight cameras and/or other sensors. Further sensors can also be present on the mobile robot 200.

One sensor may comprise a front camera 210. The front camera 210 may be generally forward facing. The sensors may also comprise front (212, 213), side and/or back stereo cameras. The front stereo cameras 212 and 213 can be slightly downward facing. The side stereo cameras (not depicted) can be forward-sideways facing. The back camera (not depicted) may be a mono or a stereo camera, which may be generally backward facing.

The sensors present on multiple sides of the robot can contribute to its situational awareness and navigation capabilities. That is, the mobile robot 200 may be configured to detect approaching objects and/or hazardous moving objects from a plurality of sides and act accordingly.

The sensors of the mobile robot 200 may also enable the mobile robot 200 to navigate and travel to its destinations at least partially autonomously. That is, the mobile robot 200 may be configured to map its surroundings, localize itself on such a map and navigate towards different destinations using in part the input received from the multiple sensors.

While in the above, a preferred embodiment has been described with reference to the accompanying drawings, the skilled person will understand that this embodiment was provided for illustrative purpose only and should by no means be construed to limit the scope of the present invention, which is defined by the claims.

While in the above, the invention is described with regards to providing assistance to a mobile robot 200, the skilled person will understand that some embodiments may also be used in combination with other autonomous vehicles such as self-driving cars.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A traffic detection device comprising
a sensor configured to detect an object of interest within its field of view;
an energy supply unit;
a communication unit; and
a housing configured to encase all other components.

2. The traffic detection device according to claim 1, wherein the sensor is configured to detect at least one of:
speed of any object of interest within its field of view; and/or
distance to any object of interest within its field of view; and/or
direction of travel of any moving object of interest within its field of view.

3. The traffic detection device according to claim 1, wherein the sensor comprises a range R1 and wherein the range R1 is up to 200 m.

4. The traffic detection device according to claim 1, wherein the sensor comprises at least one of a radar sensor, and/or a visual mono or stereo camera, and/or a time-of-flight camera, and/or a Lidar sensor.

5. The traffic detection device according to claim 1, wherein the traffic detection device comprises a mounting configured to securely fasten the housing to a support structure.

6. The traffic detection device according to claim 1, wherein the communication unit is configured to amplify and/or extend a present wireless network, and wherein the wireless network provided by the communication unit comprises a public identifier.

7. The traffic detection device according to claim 1, wherein the communication unit is configured to broadcast sensor data such that mobile robots and other traffic participants may be able to access the sensor data without a request.

8. A system for assisting mobile robots, the system comprising:
at least one mobile robot configured to navigate in an unstructured outdoor environment as a traffic participant; and
at least one traffic detection device according to claim 1,
wherein the traffic detection device is configured to assist the mobile robot by providing additional sensor data.

9. The system according to claim 8, wherein the traffic detection device is configured to assist the mobile robot upon request from the mobile robot and/or at a predetermined time.

10. The system according to claim 8, wherein the traffic detection device is configured to send sensor data to the mobile robot, said sensor data relating to conditions on the road and wherein the sensor data is reflective of a road region falling outside the mobile robot's field of view.

11. The system according to claim 8, wherein the system further comprises a server configured to communicate and exchange data with the mobile robot and the traffic detection device and wherein the server is configured to estimate a time at which the mobile robot will require an assistive function and provide the time estimate to the traffic detection device.

12. The system according to claim 8, wherein the traffic detection device is configured to provide a wireless internet connection for the mobile robot.

13. A method for assisting mobile robots, wherein the method comprises
a mobile robot approaching a road crossing;
requesting assistance for the mobile robot;
a traffic detection device providing at least one assistive function; and
in response to the assistive function, the mobile robot crossing the road.

14. The method according to claim 13, wherein the method further comprises:
the traffic detection device being in a power save mode;
the traffic detection device leaving the power save mode at fixed intervals to check whether assistive function is needed; and
upon receiving a request of a mobile robot, the traffic detection device providing at least one assistive function.

15. The method according to claim 13, the method further comprising:
monitoring mobile robot operation in a predetermined region;
estimating next time when assistance will be required by at least one mobile robot;
instructing the traffic detection device of the estimated time;
the traffic detection device entering a power save mode until shortly before the estimated time; and
upon arrival of the mobile robot, the traffic detection device providing at least one assistive function.

16. The method according to claim 13, wherein the assistive function comprises at least one of providing sensor data and/or wireless internet connection, wherein the sensor data is provided to the mobile robot directly from the traffic detection device or via a server.

17. The traffic detection device according to claim 3, wherein range R1 is up to 150 m.

18. The traffic detection device according to claim 17, wherein range R1 is up to 75 m.
